(19) United States
(12) Patent Application Publication
(10) Pub. No.: US 2017/0231860 A1
(43) Pub. Date: Aug. 17, 2017

(54) ULTRA-THIN MASSAGING CORE AND MASSAGER USING SAME

(71) Applicant: Jianhan Zou, Xiamen, Fujian Province (CN)

(72) Inventors: Jianhan Zou, Xiamen, Fujian Province (CN); Guoyun Tang, Xiamen, Fujian Province (CN); Jian Yang, Xiamen, Fujian Province (CN); Yongjin Wang, Xiamen, Fujian Province (CN)

(73) Assignee: Jianhan Zou, Xiamen, Fijian Province (CN)

(21) Appl. No.: 15/502,532

(22) PCT Filed: Oct. 14, 2014
(86) PCT No.: PCT/CN2014/088527

§ 371 Date: Feb. 8, 2017

(30) Foreign Application Priority Data
Aug. 8, 2014 (CN) 201420448116.7

(51) Int. Cl. A61H 7/00; A61H 23/02

(52) U.S. Cl. CPC A61H 7/007; A61H 23/02; A61H 23/0254; A61H 2201/0157; A61H 2201/1215; A61H 2201/1481

(57) ABSTRACT

An ultra-thin massaging core includes a housing having two supporting bases, and a kneading massage mechanism including a kneading rotary shaft, a kneading drive device and two partial pendulum type kneading massage members. Ends of the kneading rotary shaft are mounted on the supporting bases. The kneading massage members are close to the ends of the kneading rotary shaft. The kneading drive device includes a kneading motor and a kneading speed reducer. A recessed accommodation space is formed between the supporting bases. The kneading motor is provided on the accommodation space. The kneading rotary shaft is located above the kneading motor, and the two are perpendicularly staggered. A first output end of an output shaft of the kneading motor is connected with the kneading rotary shaft through the kneading speed reducer in a transmission mode. The kneading speed reducer has a U-shaped transmission structure and is small in size.

### TECHNICAL FIELD

The present invention relates to an ultra-thin massaging core and a massager using the same.

### BACKGROUND

With the technical development in the filed of massaging, massaging cores have increasingly diversified functions, including not only massaging and kneading, but also vibration massaging, walking massaging, etc. The more functions a massaging core has, the more complex structure and bulky volume it has. Therefore, existing multi-functional massaging cores generally have the drawback of being bulky.

### SUMMARY

The present invention provides an ultra-thin massaging core and a massager using the same that overcome the disadvantages in prior art. The present invention solves these technical problems using technical solution as follows:

An ultra-thin massaging core comprises a housing and a kneading massage mechanism. The kneading massage mechanism comprises a kneading rotary shaft, a kneading drive device and two partial pendulum type kneading massage member. The housing is provided with two supporting bases. The ends of the kneading rotary shaft are mounted respectively on the supporting bases, and the kneading massage member are provided close to the ends of the kneading rotary shaft. The kneading drive device comprises a kneading motor and a kneading speed reducer. A recessed accommodation space is formed between the two supporting bases. The kneading motor is provided on the accommodation space. The kneading rotary shaft is located right above the kneading motor and the kneading rotary shaft and the kneading motor are perpendicularly staggered. A first output end of an output shaft of the kneading motor is connected with the kneading rotary shaft through the kneading speed reducer in a transmission mode.

The kneading speed reducer comprises a first speed reducing component, a second speed reducing component, and a transition rotary shaft. The first speed reducing component and the second speed reducing component are connected through the transition rotary shaft mounted on the housing.

The first speed reducing component comprises a worm gear and a worm. The worm is provided on the first output end, and the worm gear is provided at one end of the transition rotary shaft. The second speed reducing component comprises a primary gear and a secondary gear. The secondary gear is provided on the kneading rotary shaft, and the primary gear is provided at the other end of the transition rotary shaft.

The primary gear and the secondary gear are connected through a transition gear in a transmission mode.

The massaging core further comprises a walking mechanism. The walking mechanism comprises a walking wheel and a walking speed reducer. The output shaft of the kneading motor has a second output end. The second output end is connected with the walking wheel through the walking speed reducer in a transmission mode.

The massaging core further comprises a walking mechanism. The walking mechanism comprises a walking motor, a walking speed reducer, and a walking wheel. The output end of the walking motor is connected with the walking wheel through the walking speed reducer in a transmission mode.

The massaging core further comprises a tapping massage mechanism. The tapping massage mechanism comprises a tapping motor, a tapping transmission component, and a tapping rotary shaft. The tapping rotary shaft is located above the transition rotary shaft and the tapping rotary shaft and the transition rotary shaft are parallel.

The tapping transmission component comprises a drive wheel, a driven wheel, and a transmission belt. The drive wheel is mounted on the output shaft of the tapping motor. The driven wheel is mounted on the tapping rotary shaft. The driven wheel and the second speed reducing component are arranged to be staggered in parallel.

The tapping motor and the kneading motor are arranged to be perpendicularly staggered. The tapping motor, the tapping rotary shaft, and the kneading rotary shaft are arranged to be parallel.

A massager comprises a casing wherein a massaging core is mounted. The massaging core comprises a housing and a kneading massage mechanism. The kneading massage mechanism comprises a kneading rotary shaft, a kneading drive device, and two partial pendulum type kneading massage member. The housing is provided with two supporting bases. The ends of the kneading rotary shaft are respectively mounted on the supporting bases. The kneading massage member are provided close to the ends of the kneading rotary shaft. The kneading drive device comprises a kneading motor and a kneading speed reducer. A recessed accommodation space is formed between the two supporting bases. The kneading motor is provided on the accommodation space. The kneading rotary shaft is located right above the kneading motor and the kneading rotary shaft and the kneading motor are perpendicularly staggered. A first output end of an output shaft of the kneading motor is connected with the kneading rotary shaft through the kneading speed reducer in a transmission mode.

The present technical solution has the following advantages over prior art:

1. The kneading rotary shaft is located right above the kneading motor and the kneading rotary shaft and the kneading motor are perpendicularly staggered so that the length of the massaging core is reduced effectively, and the massaging core has the advantage of being short.

2. The kneading speed reducer comprises a first speed reducing component, a second speed reducing component, and a transition rotary shaft. The first speed reducing component and the second speed reducing component are connected through a transition rotary shaft. The kneading speed reducer is formed with a U-shaped transmission structure and has the advantage of being small in size.

3. The massaging core further comprises a walking mechanism so that massaging core has a large massaging area. In particular, the output shaft of the kneading motor has a second output end that is connected with the walking wheel through the walking speed reducer in a transmission mode. The kneading motor drives the kneading speed reducer and the walking speed reducer simultaneously into joint operation, thus having the advantage of a low cost.

4. The massaging core further comprises a tapping massage mechanism to enhance the effect of vibration massaging. A tapping rotary shaft is located above the transition rotary shaft and the tapping rotary shaft and the transition rotary shaft are parallel, so that the massaging core has a compact structure and takes up smaller space. In particular, the tapping motor, the tapping rotary shaft, and the kneading rotary shaft are arranged to be parallel, so that the length of the massaging core can be reduced effectively.

### BRIEF DESCRIPTION OF THE DRAWINGS

Further description of the embodiments of the present invention is presented below with reference to accompanying figures, in which

FIG. 1 depicts a perspective view of a massager according to the present invention;

FIG. 2 depicts a perspective view of a massaging core of the massager shown in FIG. 1;

FIG. 3 depicts a perspective view of a housing of the massaging core shown in FIG. 2;

FIG. 4 depicts a schematic view illustrating the internal structure of the massaging core shown in FIG. 2;

FIG. 5 depicts another schematic view illustrating the internal structure of the massaging core shown in FIG. 2;

FIG. 6 depicts an exploded perspective view of a kneading massage mechanism of the massaging core shown in FIG. 2;

FIG. 7 depicts a schematic view of a massaging core of another structure according to the present invention;

FIG. 8 depicts a view illustrating the components of the transmission mechanism shown in FIG. 4; and

FIG. 9 depicts a structural view of the components of the tapping rotary shaft shown in FIG. 4.

### DETAILED DESCRIPTION OF EMBODIMENTS

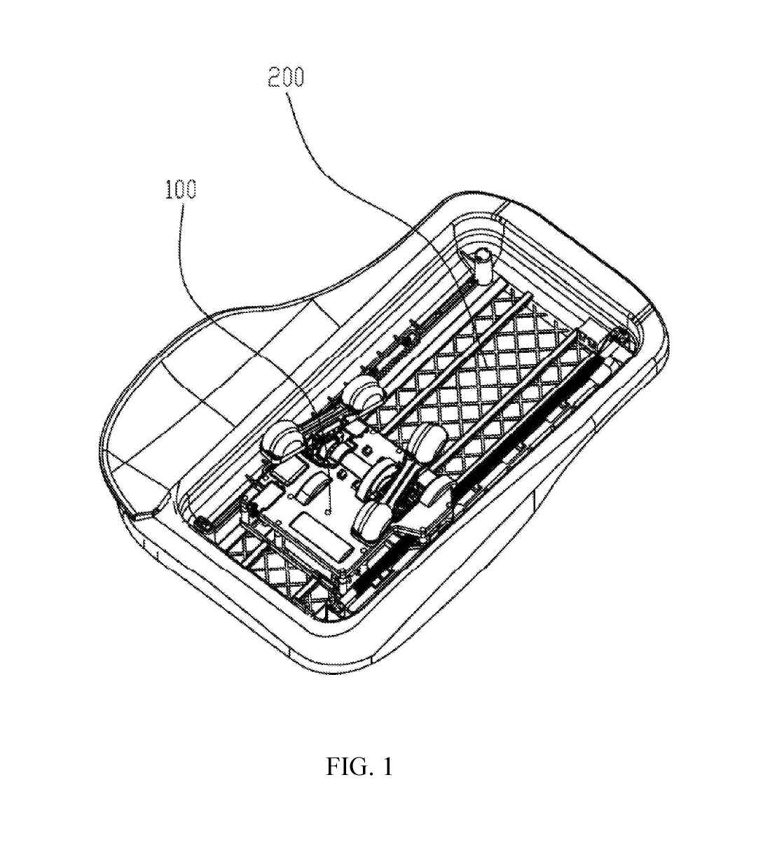

With reference to FIG. 1, a massager according to the present invention comprises an ultra-thin massaging core 100 and a casing 200. The ultra-thin massaging core 100 is mounted in the casing 200.

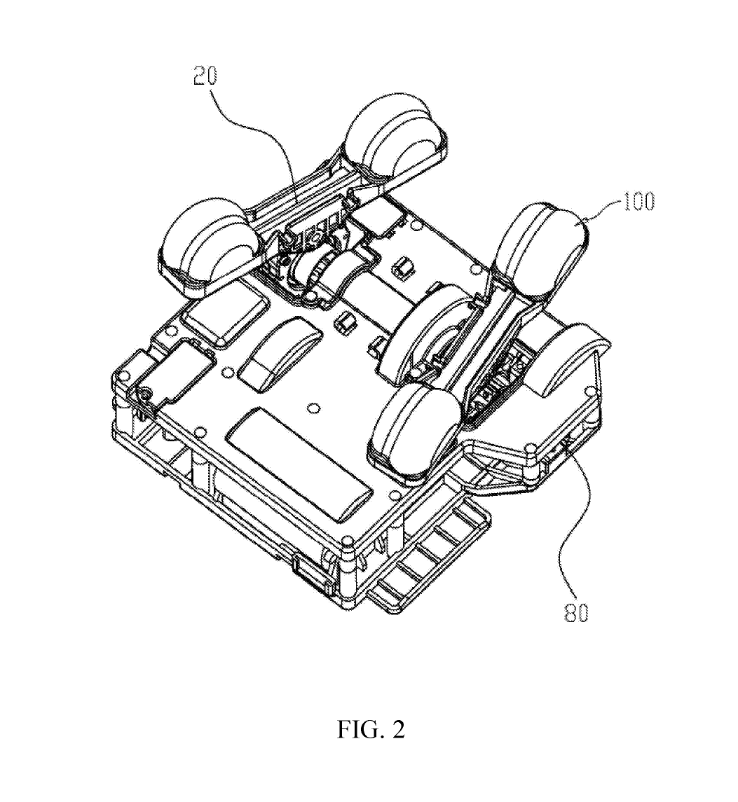

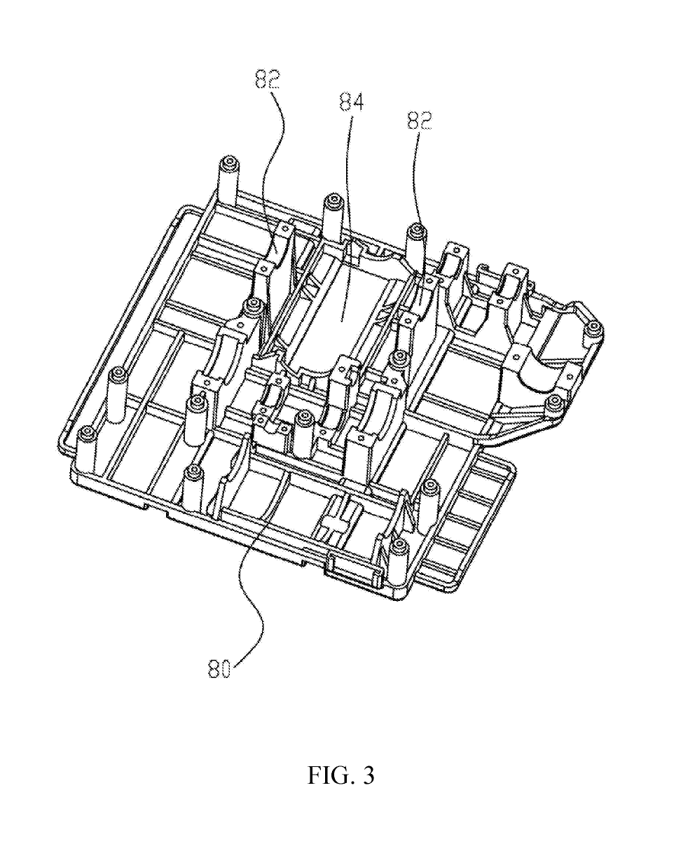

With reference to FIGS. 2 to 5, the ultra-thin massaging core 100 comprises a kneading massage mechanism 20, a walking mechanism 40, a tapping massage mechanism 60, and a housing 80. The housing 80 is provided with two supporting bases 82. A recessed accommodation space 84 is formed between the two supporting bases 82.

The kneading massage mechanism 20 comprises a kneading rotary shaft 22, a kneading drive device 24, and two partial pendulum type kneading massage member 26. The two kneading massage member 26 are respectively provided close to either end of the kneading rotary shaft 22. Each end of the kneading rotary shaft 22 is respectively mounted on one of the two supporting bases 82. The kneading drive device 24 comprises a kneading motor 242 and a kneading speed reducer 244. The kneading motor 242 is provided on the accommodation space 84. The kneading rotary shaft 22 is located right above the kneading motor 242, and the kneading rotary shaft 22 and the kneading motor 242 are perpendicularly staggered. An output shaft of the kneading motor 242 has a first output end. The first output end of the output shaft of the kneading motor 242 is connected with the kneading rotary shaft 22 through the kneading speed reducer 244 in a transmission mode.

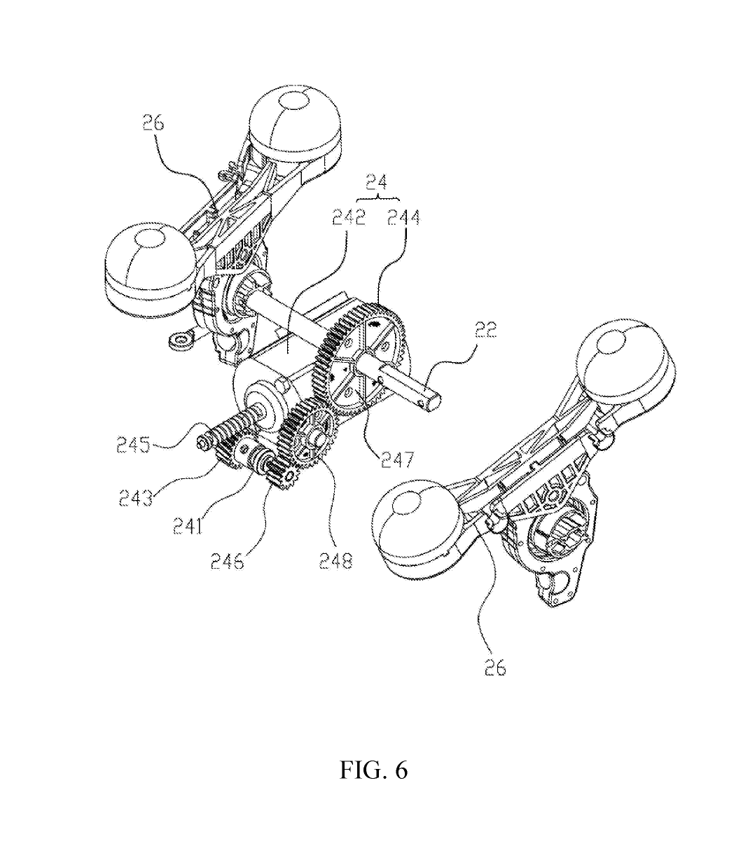

With reference to FIG. 6, the kneading speed reducer 244 comprises a first speed reducing component, a second speed reducing component, and a transition rotary shaft 241. The first speed reducing component and the second speed reducing component are connected through the transition rotary shaft 241. The kneading speed reducer generally forms a U-shaped transmission structure. The transition rotary shaft 241 is mounted on the housing 80.

The first speed reducing component comprises a worm gear 243 and a worm 245. The worm 245 is provided on the first output end of the kneading motor 242, and the worm gear 245 is provided on an end of the transition rotary shaft 241. The second speed reducing component comprises a primary gear 246, a secondary gear 247, and a transition gear 248. The secondary gear 247 is provided on the kneading rotary shaft 22, and the primary gear 246 is provided on the other end of the transition rotary shaft 241. The primary gear 246 and the secondary gear 247 are connected through the transition gear 248 in a transmission mode.

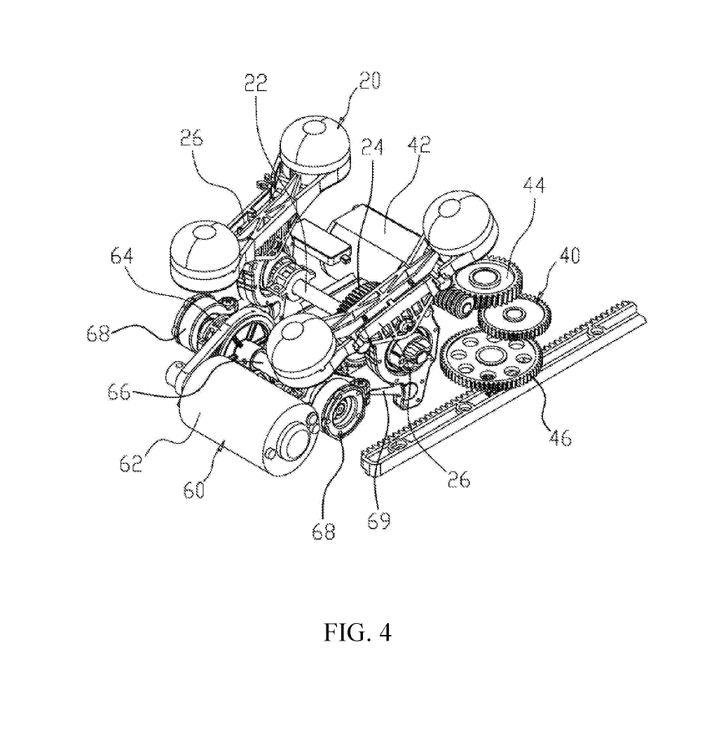

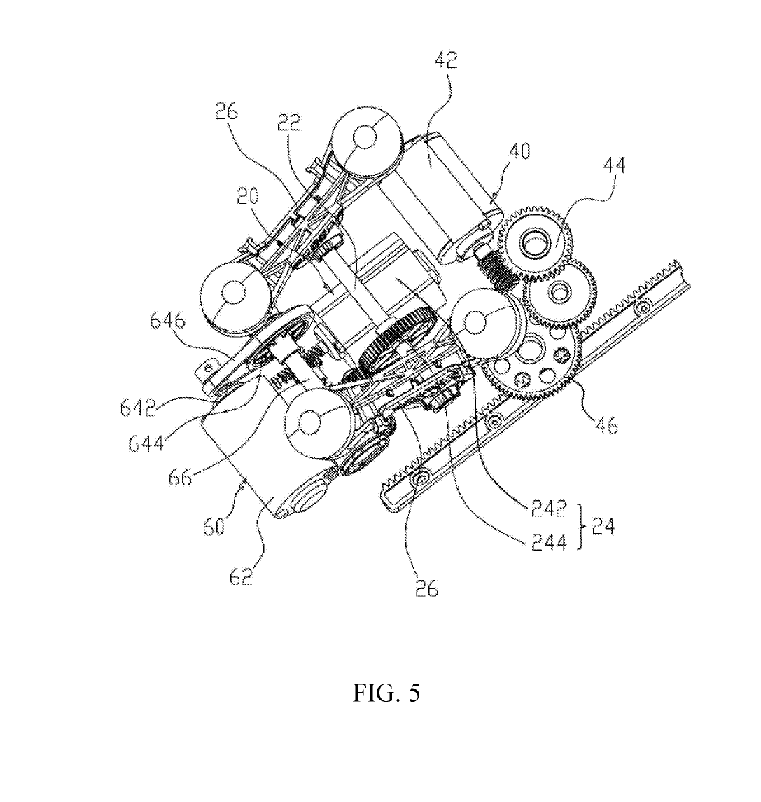

With reference to FIGS. 4 and 5, the walking mechanism comprises a walking motor 42, a walking speed reducer 44, and a walking wheel 46. An output end of the walking motor 42 is connected with the walking wheel 46 through the walking speed reducer 44 in a transmission mode.

With reference to FIGS. 4, 5, and 6, the tapping massage mechanism 60 comprises a tapping motor 62, a tapping transmission component 64, a tapping rotary shaft 66, a pendulum 68, and a tapping linkage 69. The tapping rotary shaft 66 is located above the transition rotary shaft 241, and the tapping rotary shaft 66 and the transition rotary shaft 241 are parallel. The tapping transmission component 64 comprises a drive wheel 642, a driven wheel 644, and a transmission belt 646. The drive wheel 642 is mounted on the output shaft of the tapping motor 62. The driven wheel 644 is mounted on the tapping rotary shaft 66. The driven wheel 644 and the second speed reducing component are arranged to be staggered in parallel. The tapping rotary shaft 66 is provided with a eccentric rotor 28. The axis of the eccentric rotor 28 offsets from the axis of the tapping rotary shaft 66. When the tapping rotary shaft 66 rotates, the axis of the eccentric rotor 28 rotates about the axis of the tapping rotary shaft 66, so that the eccentric rotor 28 is moves eccentrically. The eccentric rotor 28, located on an end of the tapping rotary shaft 66 in this embodiment, may be an element mounted on the tapping rotary shaft 66 or be machined from the end of the tapping rotary shaft 66 (with reference to FIG. 6), as long as it is ensured that its axis offsets from the axis of the tapping rotary shaft 66. The pendulum 68 is mounted on the eccentric rotor 28 so as to be driven to swing circumferentially. The pendulum 68 is mounted on the eccentric rotor 28 through an eccentric bearing 29. As the eccentric rotor 28 rotates, the pendulum 68 swings circumferentially. The tapping linkage 69 links the massaging member and the pendulum 68. One end of the tapping linkage 69 is movably connected to the pendulum 68 through a pin, and the other end of the tapping linkage 69 is movably connected to the massaging member through a ball joint. When the pendulum 68 swings, the tapping linkage 69 pulls the massaging member to swing axially to cause a tapping massage motion.

The pendulum 68 is connected to each end of the tapping rotary shaft 66 respectively for one of two eccentric bushings. When the tapping rotary shaft 66 rotates, the eccentric bushings 68 are driven to rotate eccentrically. Each tapping linkage 69 connects an eccentric bushing 68 and a kneading massage member 26. As such, when the eccentric bushing 68 is rotating eccentrically at a high speed, the kneading massage member 26 can be driven to cause vibration massage effects. The tapping motor 62 and the kneading motor 242 are arranged to be perpendicularly staggered. The tapping motor 62, the tapping rotary shaft 66, and the kneading rotary shaft 22 are arranged to be parallel.

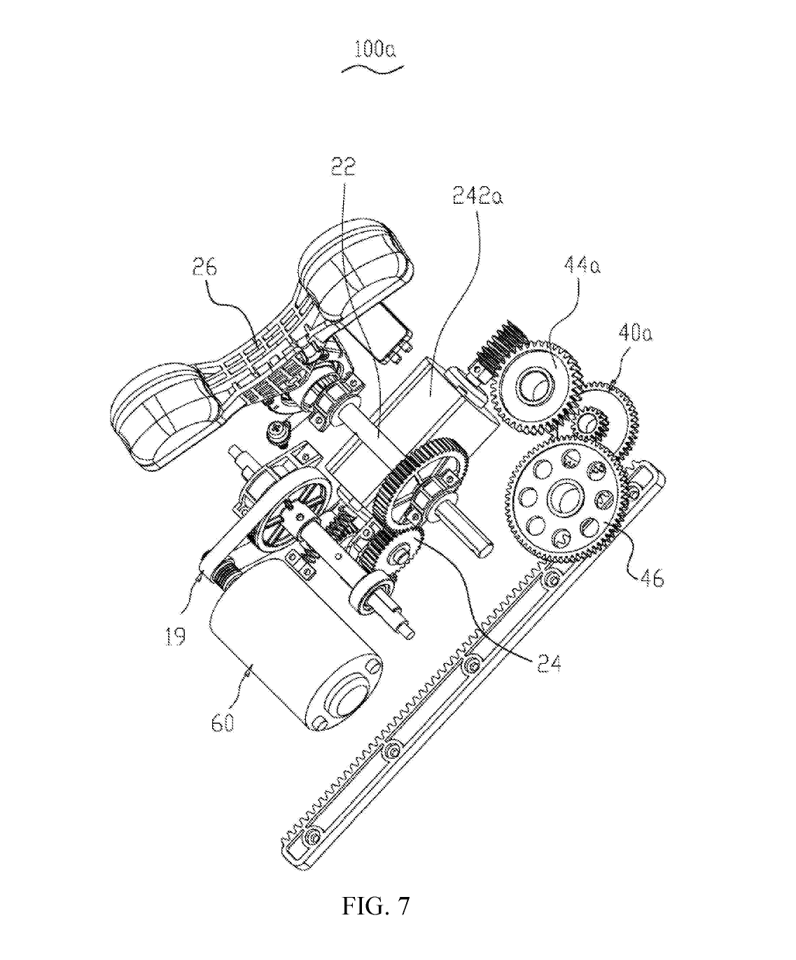

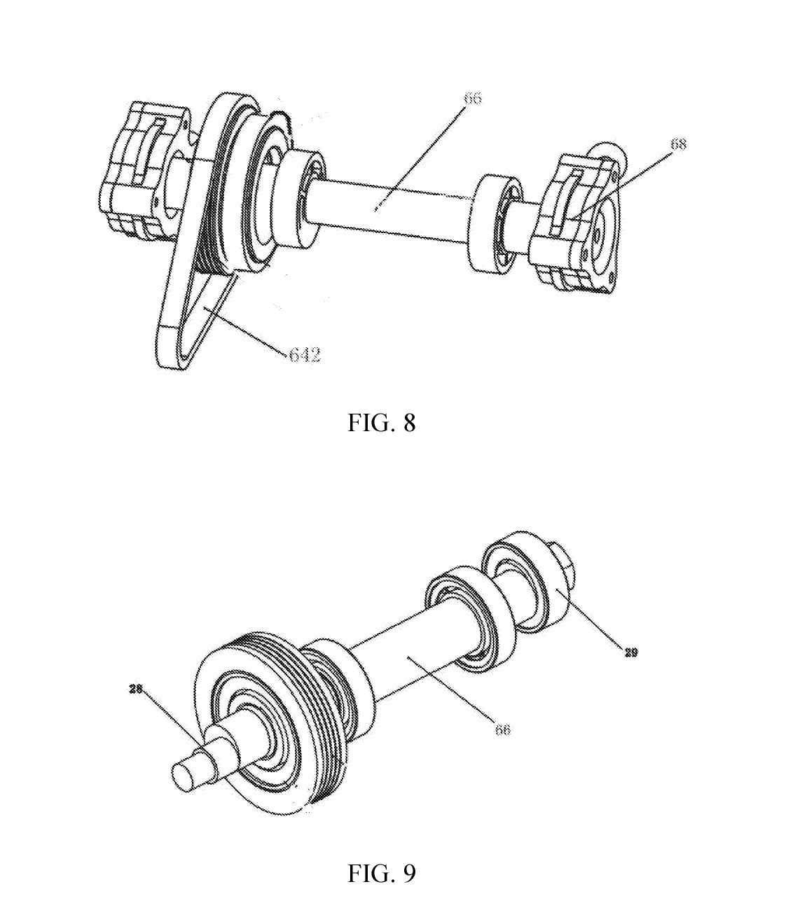

With reference to FIG. 7, which depicts a schematic view of a massaging core of another structure according to the present invention, the massaging core 100a shown in FIG. 7 differs from the massaging core 100 described above in that the walking mechanism 40a comprises a walking wheel 46 and a walking speed reducer 44a, the output shaft of the kneading motor 242a further has a second output end that is connected to the walking wheel 46 through a walking speed reducer 44a in a transmission mode.

Described above is only a preferred embodiment of the present invention and thus is not intended to limit the scope of the present invention. Therefore, any equivalent variation and modification made in light of the claims and specification of the present invention falls within the scope of the present invention.

1. An ultra-thin massaging core comprising a housing and a kneading massage mechanism, wherein the kneading massage mechanism comprises a kneading rotary shaft, a kneading drive device, and two partial pendulum type kneading massage member, the housing is provided with two supporting bases, ends of the kneading rotary shaft are respectively mounted on the supporting bases, the kneading massage member are provided close to the ends of the kneading rotary shaft, and the kneading drive device comprises a kneading motor and a kneading speed reducer, wherein a recessed accommodation space is formed between the two supporting bases, a kneading motor is provided on the accommodation space, the kneading rotary shaft is located right above the kneading motor and the kneading rotary shaft and the kneading motor are perpendicularly staggered, and a first output end of an output shaft of the kneading motor is connected with the kneading rotary shaft through the kneading speed reducer in a transmission mode.

2. The ultra-thin massaging core according to claim 1, wherein the kneading speed reducer comprises a first speed reducing component, a second speed reducing component, and a transition rotary shaft, the first speed reducing component and the second speed reducing component are connected through the transition rotary shaft, and the transition rotary shaft is mounted on the housing.

3. The ultra-thin massaging core according to claim 2, wherein the first speed reducing component comprises a worm gear and a worm, the worm is provided on the first output end, the worm gear is provided on one end of the transition rotary shaft, the second speed reducing component comprises a primary gear and a secondary gear, the secondary gear is provided on the kneading rotary shaft, and the primary gear is provided on the other end of the transition rotary shaft.

4. The ultra-thin massaging core according to claim 3, wherein the primary gear and the secondary gear are connected through a transition gear in a transmission mode.

5. The ultra-thin massaging core according to claim 1, wherein the massaging core further comprises a walking mechanism, the walking mechanism comprises a walking wheel and a walking speed reducer, and an output shaft of the kneading motor has a second output end that is connected with the walking wheel through the walking speed reducer in a transmission mode.

6. The ultra-thin massaging core according to claim 1, wherein the massaging core further comprises a walking mechanism, the walking mechanism comprises a walking motor, a walking speed reducer, and a walking wheel, and an output end of the walking motor is connected to the walking wheel through the walking speed reducer in a transmission mode.

7. The ultra-thin massaging core according to claim 2, wherein the massaging core further comprises a tapping massage mechanism, the tapping massage mechanism comprises a tapping motor, a tapping transmission component, and a tapping rotary shaft, the tapping rotary shaft is located above the transition rotary shaft, and the tapping rotary shaft and the transition rotary shaft are parallel.

8. The ultra-thin massaging core according to claim 7, wherein the tapping transmission component comprises a drive wheel, a driven wheel, and a transmission belt, the drive wheel is mounted on an output shaft of the tapping motor, the driven wheel is mounted on the tapping rotary shaft, and the driven wheel and the second speed reducing component are arranged to be staggered in parallel.

9. The ultra-thin massaging core according to claim 7, wherein the tapping motor and the kneading motor are arranged to be perpendicularly staggered, and the tapping motor, the tapping rotary shaft, and the kneading rotary shaft are arranged to be parallel.

10. A massager comprising a casing, wherein the massaging core according to claim 1 is mounted in the casing.
